(19) United States
(12) Patent Application Publication
(10) Pub. No.: US 2011/0292868 A1
(43) Pub. Date: Dec. 1, 2011

(54) Method and Apparatus for Increasing the Capacity and Coverage of a Multi-Sector, Omni Site

(76) Inventors: Ulf Sk+e,uml a+ee rby, Lidingo (SE); Donald Stephen Staudte, Huddinge (SE)

(21) Appl. No.: 12/786,544

(22) Filed: May 25, 2010

(51) Int. Cl. H04W 40/00

(52) U.S. Cl. 370/328

(57) ABSTRACT

A base station unit of a multi-sector omni-radio base station sends different transmit signals to first and second splitters, via first and second feeders, respectively, according to transmit diversity, spatial multiplexing, or both. The first splitter splits the transmit signal sent thereto amongst sector antennas in a first set of sector antennas, and the second splitter splits the transmit signal sent thereto among sector antennas in a second set of sector antennas. These first and second sets provide coverage for some of the same sectors of a geographic area. Finally, first and second combiners combine signals received by the sector antennas in the first or second set, respectively, at least one of those signals having first been converted to a different frequency, and send the resulting composite signal to the base station unit, via the first or second feeder, respectively.

### TECHNICAL FIELD

This invention relates generally to multi-sector, omni sites and particularly to increasing the capacity and coverage of multi-sector, omni sites.

### BACKGROUND OF THE INVENTION

An omni-base station is a base station configured to use an omni-antenna, and a sector base station is a base station configured to use multiple, i.e. two or more, sector antennas. FIG. 1A, for example, shows an omni-base station with an omni-antenna. An omni-antenna radiates 360 degrees to provide coverage over an entire geographic area (defined, e.g., as a cell). FIG. 1B by contrast shows a sector base station with three sector antennas. In this example, the geographic area is divided into thirds, with each sector antenna having a narrower beam, as compared to an omni-antenna, that radiates to provide coverage over its sector area of approximately 120 degrees.

A base station antenna, whether it be an omni-antenna or a sector antenna, is often mounted in an elevated location, such as on a tower, a pole, on the top or sides of buildings, etc., to enhance coverage and provide better possibilities for direct radio signal propagation paths. FIG. 1C shows a base station unit 14 located at the base of a tower 12. An antenna 10 is mounted on the top of the tower 12 and is coupled to the base station transceiver via a feeder 16, typically a coaxial cable or the like. The received signal suffers signal losses traversing the feeder 16, and the taller the tower 12, the longer the feeder, and the greater the loss. In an attempt to offset such signal losses in the feeder 16, a tower-mounted amplifier (TMA) may be used to amplify the received signal before it is sent over the feeder 16 to the base station unit 14, as shown in FIG. 1D.

Because omni-base stations use only a single, omni-antenna, they use only a single feeder and a single TMA. They are thus less complex and less expensive than sector base stations, which use, e.g., three sector antennas, three feeder cables, and three TMAs. Yet sector base stations provide more coverage than omni-base stations.

U.S. patent application Ser. No. 11/607,082, which is commonly owned with the present application, discloses a so-called multi-sector, omni-radio base station that provides more coverage than an omni-base station, at a cost less than a sector base station. A multi-sector, omni-radio base station includes an omni-base station coupled to a multi-sector antenna system. Use of a multi-sector antenna system provides increased signal gain (e.g., approximately 7-9 dB for a three-sector antenna system). To reduce the cost associated with use of multiple sector antennas, the multi-sector, omni-radio base station includes a splitter/combiner that permits use of fewer feeders than sector antennas. The splitter/combiner combines uplink signals received from two or more sector antennas onto a single feeder cable. To prevent or mitigate signal loss in the splitter/combiner (which would offset the signal gain achieved from use of the multi-sector antenna system), the uplink signals are converted to different frequencies by a so-called frequency shifting TMA before being combined.

### SUMMARY

Teachings herein advantageously increase the capacity of a multi-sector, omni-radio base station, and further increase the coverage of such a base station, by sending different transmit signals from a base station unit according to transmit diversity and/or spatial multiplexing. The different transmit signals are sent over different feeders to different splitters, which each split the signal received amongst the sector antennas in a set of sector antennas.

In one embodiment, for example, a base station includes a first set of sector antennas and a second set of sector antennas. The sector antennas in the first set provide coverage for different sectors of a geographic area, and the sector antennas in the second set provide coverage for some of those same sectors. The base station further includes a first splitter and a second splitter. The first splitter is configured to receive a signal sent to it and to then split that signal amongst the sector antennas in the first set. By splitting the signal amongst the sector antennas in the first set, the first splitter provides the signal to each of those sector antennas, but at a fraction of the power. Likewise, the second splitter is configured to receive a signal sent to it and to split that signal amongst the sector antennas in the second set.

With the base station configured in this way, the base station unit sends different transmit signals to the first and second splitters, via first and second feeders, respectively. The base station unit advantageously does so by sending the transmit signals according to transmit diversity, spatial multiplexing, or both.

To advantageously receive signals using this same structure, the base station further includes a first combiner and a second combiner. The first combiner is configured to combine signals received by the sector antennas in the first set and to send the resulting composite signal to the base station unit, via the first feeder. Notably, to prevent or at least mitigate interference between these received signals when they are combined in the first combiner, at least one of those signals is first converted to a frequency different from that at which it was received. In much the same way, the second combiner is configured to combine signals received by the sector antennas in the second set and to send the resulting composite signal to the base station unit, via the second feeder.

The base station unit thus receives two composite signals, one from the first combiner via the first feeder and another from the second combiner via the second feeder. The base station unit in some embodiments is configured to receive these composite signals according to receive diversity, spatial multiplexing, or both.

This embodiment can be also viewed as a multi-sector omni-radio base station that has two transmit branches and two receive branches. The base station in other embodiments may have more than two transmit branches and more than two receive branches, with the number of transmit branches not necessarily being equal to the number of receive branches and not necessarily being equal to the number of sets of sector antennas.

The present invention is therefore not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1A is a schematic block diagram illustrating a single cell area for a base station with an omni antenna.

FIG. 1B is a schematic block diagram illustrating a single cell area for a base station with three sector antennas.

FIG. 1C is a block diagram illustrating a base station tower.

FIG. 1D is a block diagram illustration a base station tower with a tower-mounted amplifier.

FIG. 2 is a block diagram of a mobile communication system according to one embodiment of the present invention.

FIGS. 3A-3B are block diagrams of a multi-sector omni-radio base station according to one embodiment of the present invention.

FIGS. 4A and 4B are block diagrams of a multi-sector omni-radio base station according to another embodiment of the present invention.

FIGS. 5A and 5B are block diagrams of frequency converters according to various embodiments of the present invention.

FIG. 6 is a logic flow diagram illustrating a method implemented in a base station for providing communication coverage to a geographic area according to one embodiment of the present invention.

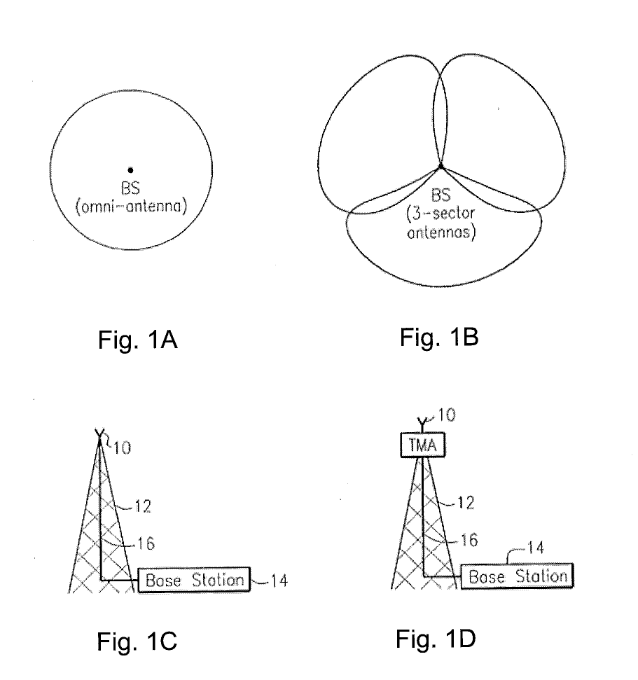

### DETAILED DESCRIPTION

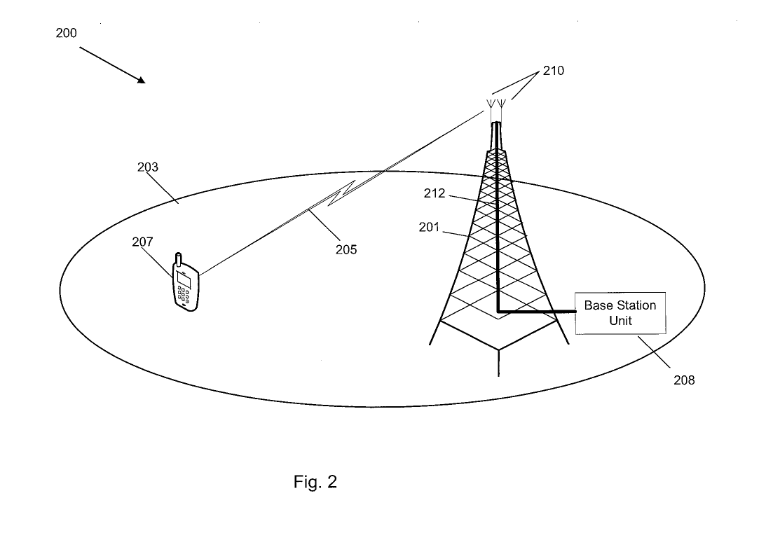

FIG. 2 illustrates a mobile communication system 200 that includes a multi-sector, omni-radio base station 201 and a mobile terminal 207. The multi-sector, omni-radio base station 201 (referred to hereinafter as simply “base station 201”) is configured to provide radio communication coverage for a geographic area 203 in which one or more mobile terminals 207 are located. To do so, the base station 201 includes a base station unit 208 located at the base of a tower and a plurality of sector antennas 210 mounted on top of the tower. The sector antennas 210 are coupled to the base station unit 208 via a plurality of feeders 212, which are typically coaxial cables. The base station unit 208 sends downlink signals over the feeders 212, to the sector antennas 210, which transmit the downlink signals over one or more radio carriers 205 to mobile terminals 207. Similarly, the mobile terminals 207 transmit uplink signals over the radio carriers 205 to the sector antennas 210, which send the uplink signals over the feeders 212 to the base station unit 208.

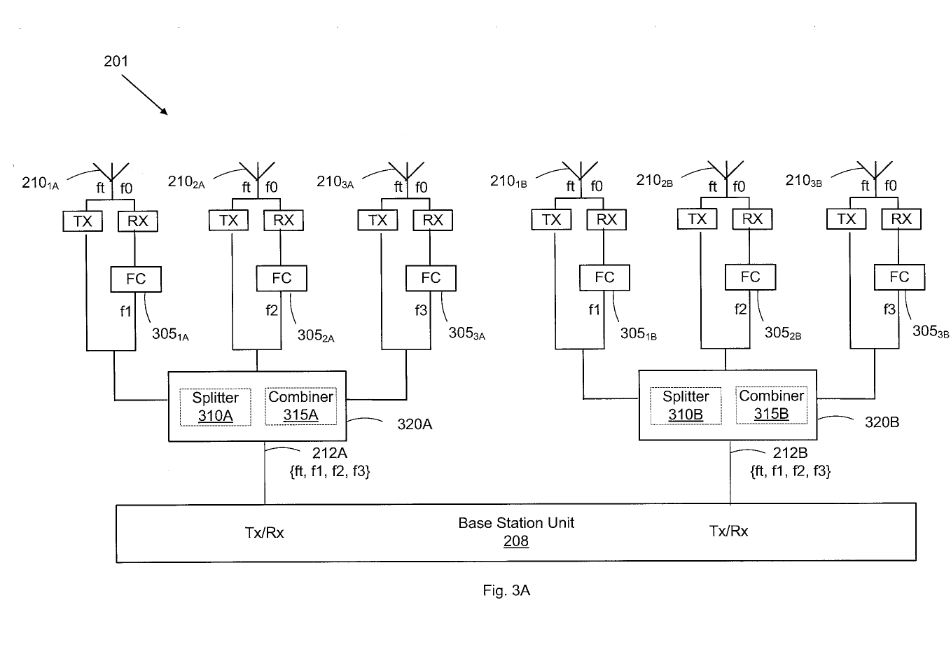

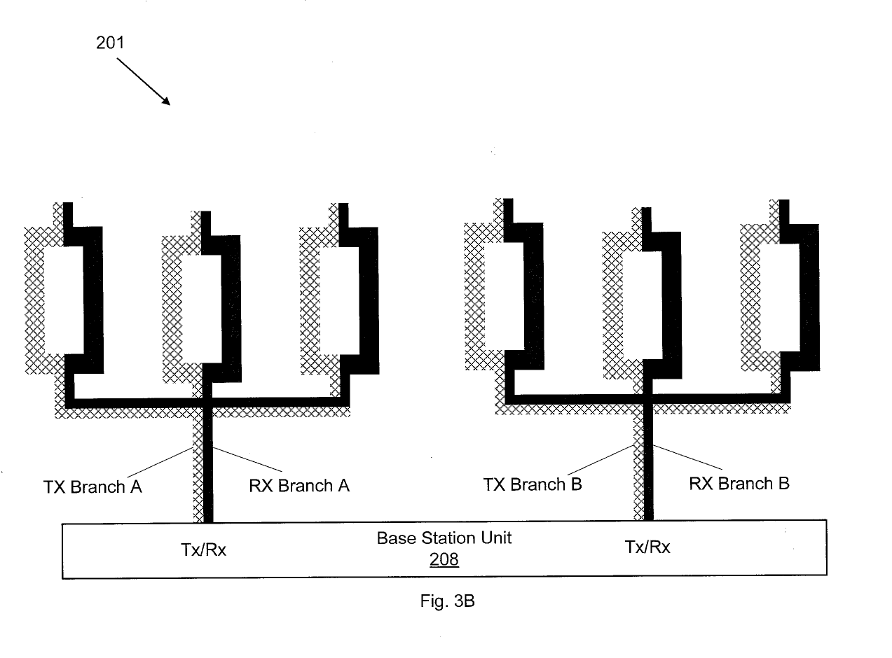

More particularly, FIGS. 3A-3B illustrate a three-sector omni-radio base station 201 as an example of various embodiments of the present invention. In FIG. 3A, the base station 201 includes a first set of sector antennas {210_{1A}, 210_{2A}, and 210_{3A}} and a second set of sector antennas {210_{1B}, 210_{2B}, and 210_{3B}}. The sector antennas in the first set provide coverage for different sectors of the geographic area 203 (e.g., sector antenna 210_{1A} provides coverage for sector 1, sector antenna 210_{2A} provides coverage for sector 2, and sector antenna 210_{3A} provides coverage for sector 3). The sector antennas in the second set generally provide coverage for some of the same sectors, and as shown in FIG. 3A provide coverage for all of the same sectors (e.g., sector antenna 210_{1B} also provides coverage for sector 1, sector antenna 210_{2B} also provides coverage for sector 2, and sector antenna 210_{3B} also provides coverage for sector 3).

The base station 201 further includes a first splitter 310A and a second splitter 310B. The first splitter 310A is configured to receive a signal sent to it and to then split that signal amongst the sector antennas in the first set {210_{1A}, 210_{2A}, and 210_{3A}}. By splitting the signal amongst the sector antennas in the first set, the first splitter 308A provides the signal to each of those sector antennas, but at a fraction of the power (e.g., at one-third power, where splitting the signal equally amongst three sector antennas). Likewise, the second splitter 310B is configured to receive a signal sent to it and to split that signal amongst the sector antennas in the second set {210_{1B}, 210_{2B}, and 210_{3B}}.

With the base station 201 configured in this way, the base station unit 208 sends different transmit signals to the first and second splitters 310A,B, via first and second feeders 212A,B, respectively. The base station unit 201 advantageously does so by sending the transmit signals according to transmit diversity, spatial multiplexing, or both.

For example, in the case that the base station unit 208 sends the transmit signals according to transmit diversity, the base station unit 208 sends transmit signals that represent the same data, but that differ in one or more transmission parameters (e.g., time, coding, or the like). That is, the transmit signal sent over the first feeder 212A to the first splitter 310A (and ultimately transmitted by the first set of sector antennas) represents the same data as the transmit signal sent over the second feeder 212B to the second splitter 310A (and ultimately transmitted by the second set of sector antennas), but differs in one or more transmission parameters. This allows the base station 201 to provide better coverage to a mobile terminal 207 by providing the mobile terminal 207 with additional diversity against fading on the radio channel.

Alternatively, in the case that the base station unit 208 sends the transmit signals according to spatial multiplexing, the base station unit 208 sends transmit signals that represent different data. In other words, the transmit signal sent over the first feeder 212A to the first splitter 310A (and ultimately transmitted by the first set of sector antennas) represents different data than the transmit signal sent over the second feeder 212B to the second splitter 310A (and ultimately transmitted by the second set of sector antennas). This allows the base station 201 to provide higher data rates to a mobile terminal 207 by transmitting multiple data streams in parallel.

To advantageously receive signals using this same structure, the base station 201 further includes a first combiner 315A and a second combiner 315B. The first combiner 315A may be associated with, or included in the same physical unit as, the first splitter 310A, and therefore referred to as splitter/combiner 320A. Likewise, the second combiner 315B may be associated with, or included in the same physical unit as, the second splitter 310B, and therefore referred to as splitter/combiner 320B.

Regardless, the first combiner 315A is configured to combine signals received by the sector antennas in the first set {210_{1A}, 210_{2A}, and 210_{3A}} and to send the resulting composite signal to the base station unit 208, via the first feeder 212A. Notably, to prevent or at least mitigate interference between these received signals when they are combined in the first combiner 315A, at least one of those signals is first converted to a frequency different from that at which it was received.

As shown in FIG. 3A, for example, each sector antenna in the first set {210_{1A}, 210_{2A}, and 210_{3A}} receives signals at the same frequency f0. Before the signals are combined, frequency converters (FCs) 305_{1A}, 305_{2A}, and 305_{3A} interposed between the antennas and the first combiner 315A convert those signals to three different frequencies, f1, f2, and f3. The first combiner 315A thus combines the received signals to form a composite signal that has frequencies {f1, f2, f3} and sends that composite signal to the base station unit 208 via the first feeder 212A.

In much the same way, the second combiner 315B is configured to combine signals received by the sector antennas in the second set {210_{1B}, 210_{2B}, and 210_{3B}} and to send the resulting composite signal to the base station unit 208, via the second feeder 212B. At least one of these signals is also first converted to a frequency different from that at which it was received (e.g., by frequency converters 305_{1B}, 305_{2B}, and 305_{3B}).

The base station unit 208 thus receives two composite signals, one from the first combiner 315A via the first feeder 212A and another from the second combiner 315B via the second feeder 212B. The base station unit 208 in some embodiments is configured to receive these composite signals according to receive diversity, spatial multiplexing, or both. Where the base station unit 208 is configured to receive the composite signals according to receive diversity, the base station unit 208 receives composite signals that represent the same data, but that differ in one or more transmission parameters. Thus in this case the base station unit 208 is configured to jointly process the composite signals to combat fading of the radio channel (e.g., by dynamically selecting the signal with the best quality, by combining the signals, or the like).

Alternatively where the base station unit 208 is configured to receive the composite signals according to spatial multiplexing (also known as uplink spatial multiplexing), the base station unit 208 receives composite signals that represent different data. In this case therefore the base station unit 208 is configured to achieve higher data rates by receiving multiple data streams in parallel. The base station unit 208 may also receive the composite signals according to any combination of spatial multiplexing and receive diversity, and may further receive signals sent by mobile terminals according to uplink transmit diversity.

Note that the base station 201 may transmit and receive as described above simultaneously by using different transmit and receive frequencies (i.e., frequency division duplexing, FDD). As shown, for example, the sector antennas 210 receive signals at frequency f0 and transmit signals at frequency ft (which is different than f0, f1, f2, or f3), with transmit filters (TX) and receive filters (RX) enabling such transmission and reception to occur simultaneously. Accordingly, at any given time, signals being sent over the feeders 212A,B have different frequencies {ft, f1, f2, f3} and do not interfere with one another. Of course, those skilled in the art will appreciate that in other embodiments time division duplexing may be used such that the sector antennas 210 transmit and receive signals at the same frequency, but at different times.

The above embodiments can be also viewed as including a multi-sector omni-radio base station 201 that has two transmit branches and two receive branches. Consider, for instance, FIG. 3B, which overlays graphical depictions onto the two transmit branches (A and B) and the two receive branches (A and B) in FIG. 3A. Transmit branch A and receive branch A share a common feeder 212A and splitter/combiner 320A, and share the first set of sector antennas {210_{1A}, 210_{2A}, and 210_{3A}}. Receive branch A, however, includes frequency converters 305_{1A}, 305_{2A}, and 305_{3A}. The same can be said for transmit branch B and receive branch B.

Those skilled in the art will of course appreciate that the above description and figures represent non-limiting examples of the present invention. Indeed, while the example above described a base station 201 with two transmit branches and two receive branches, the base station 201 may have more than two transmit branches and more than two receive branches, with the number of transmit branches not necessarily being equal to the number of receive branches and not necessarily being equal to the number of sets of sector antennas. In one embodiment, for example, the base station 201 has four receive branches and two transmit branches,

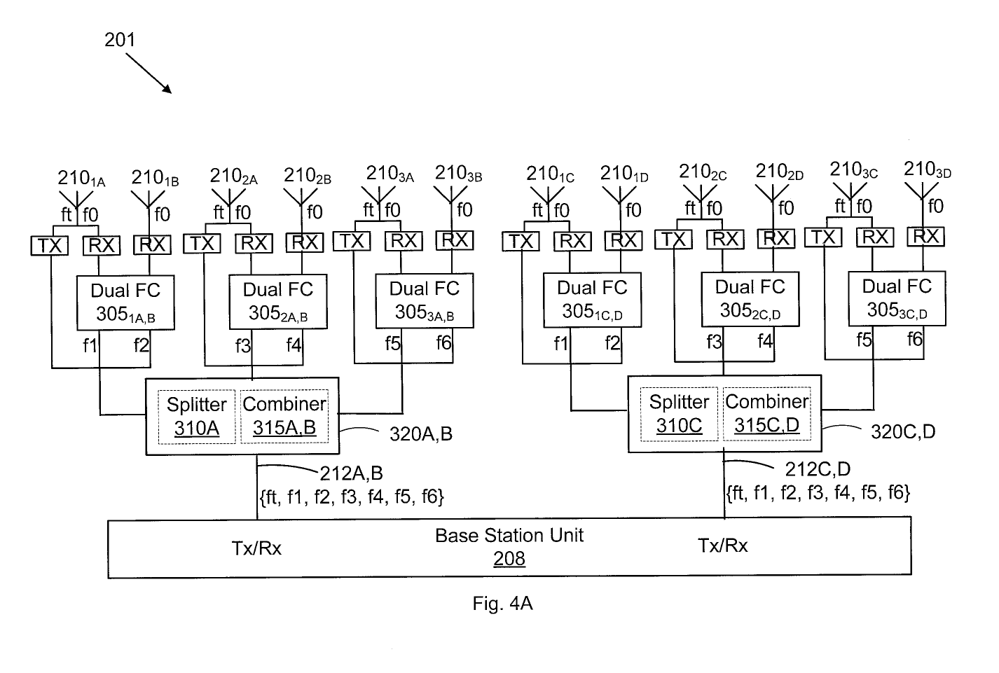

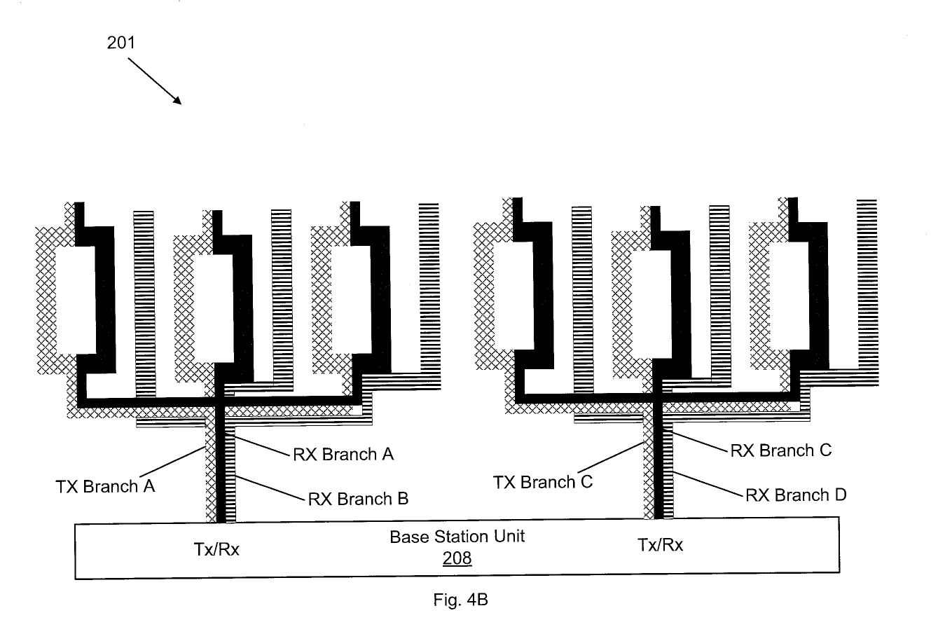

FIGS. 4A-4B illustrate an example of this embodiment. The base station 201 includes four sets of sector antennas, a first set {210_{1A}, 210_{2A}, and 210_{3A}}, a second set {210_{1B}, 210_{2B}, and 210_{3B}}, a third set {210_{1C}, 210_{2C}, and 210_{3C}}, and a fourth set {210_{1D}, 210_{2D}, and 210_{3D}}. The first and third sets are configured to both transmit and receive, while the second and third sets are configured only to receive, for additional receive diversity.

More particularly, the base station unit 208 sends different transmit signals to splitters 310A and 310C, via feeders 212A,B and 212C,D, respectively, according to transmit diversity, spatial multiplexing, or both. Splitter 310A splits the transmit signal sent to it amongst the sector antennas in the first set {210_{1A}, 210_{2A}, and 210_{3A}}, while splitter 310C splits the transmit signal sent to it amongst the sector antennas in the third set {210_{1C}, 210_{2C}, and 210_{3C}}. With transmit signals sent in this way, the base station 201 has two transmit (TX) branches, A and C, as graphically shown in FIG. 4B.

Signals received by sector antennas in the first set {210_{1A}, 210_{2A}, and 210_{3A}}, and signals received by sector antennas in the second set {210_{1B}, 210_{2B}, and 210_{3B}} are all combined by combiner 315A,B to form one composite signal, which is sent to the base station unit 208 via feeder 212A,B. Before being combined, each of the signals is converted to a different frequency by dual frequency converters 305_{1A,B}, 305_{2A},B, and 305_{3A,B}. Combiner 315A,B thus combines the received signals to form a composite signal that has six different frequencies {f1, f2, f3, f4, f5, and f6} and sends that composite signal to the base station unit 208 via feeder 212A,B.

In much the same way, signals received by sector antennas in the third set {210_{1C}, 210_{2C}, and 210_{3C}}, and signals received by sector antennas in the fourth set {210_{1D}, 210_{2D}, and 210_{3D}} are all combined by combiner 315C,D to form one composite signal, which is sent to the base station unit 208 via feeder 212C,D. Before being combined, each of the signals is converted to a different frequency by dual frequency converters 305_{1C,D}, 305_{2C,D}, and 305_{3C,D}. The dual frequency converters each convert two signals to two different frequencies, as opposed to converting just one signal to a different frequency. Thus, combiner 315C,D combines the received signals to form a composite signal that has six different frequencies {f1, f2, f3, f4, f5, and f6} and sends that composite signal to the base station unit 208 via feeder 212C,D. With signals received in this way, the base station 201 has four receive (RX) branches, A, B, C, and D, as graphically shown in FIG. 4B.

With an appreciation of the above embodiments, those skilled in the art will recognize that the number of transmit branches, not necessarily the number of receive branches, corresponds to the number of splitters 310 and the number of feeders 212. More fundamentally, the number of transmit branches in some embodiments corresponds to the number of power amplifiers included in the base station unit 208. That is, in some embodiments the base station unit 208 includes a plurality of power amplifiers configured to amplify transmit signals, and the base station has as many splitters 310, and as many feeders 212, as there are of those power amplifiers.

Those skilled in the art will also appreciate that while the example above described a three sector omni-radio base station 201, with three sector antennas 210 in each set of sector antennas, the base station 201 may be configured for any number of sectors greater than or equal to two. That is, the number of sectors, and thereby the number of sector antennas 210 per set, may be two or greater.

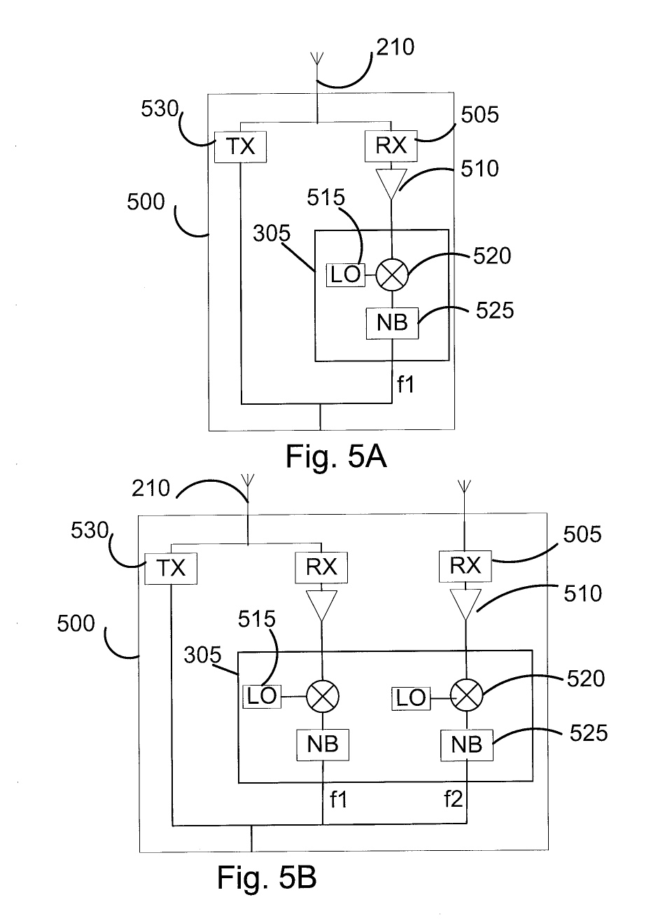

FIGS. 5A-5B show additional details of single and dual frequency converters 305, respectively, and other additional details of transmit and receive branches, according to some embodiments. In FIG. 5A, a frequency converter 305 for a receive branch is included in a tower mounted amplifier (TMA) 500. The TMA 500 includes a receive (RX) filter 505 that is configured to pass an uplink signal received by sector antenna 210 at receive frequency f0, and a transmit (TX) filter 530 that is configured to pass a downlink signal transmitted by sector antenna 210 at transmit frequency ft. The TMA 500 further includes an amplifier 510 that amplifies the filtered uplink signal in order to offset signal loss caused by traversal of a feeder 212. This amplifier 510 is coupled to a frequency converter 305, which includes a local oscillator (LO) 515, a mixer 520, and a narrowband (NB) filter 525. The mixer 520 is configured to mix the amplified and filtered uplink signal with a frequency translating signal generated by local oscillator 515, to convert the uplink signal to a different frequency f1. The mixer's output is then filtered using narrowband filter 525 centered on frequency f1, to remove other mixer products as well as noise and interference.

Similarly, in FIG. 5B, a dual frequency converter 305 for two receive branches is included in a TMA 500. The dual frequency converter 305 includes two different local oscillators 515, so as to convert the uplink signal received on one receive branch to a different frequency f1, while converting the uplink signal received on the other receive branch to a different frequency f2.

Of course, FIGS. 5A-5B illustrate non-limiting examples of frequency converters 305. In other embodiments, a frequency converter 305 includes an intermediate frequency (IF) conversion, and other additional processing, before ultimately providing frequency converted uplink signal(s) to a splitter/combiner 320. Moreover, the illustrated dual frequency converter may be extended to a multi-signal frequency converter, configured to convert any number of signals to different frequencies that are both different from one another and different from any frequency at which the signals were received. Similar circuitry may be included in the base station unit 208 for restoring the uplink signals once transferred via the feeders 212.

Although the embodiments described above have included frequency converters 305 for converted each signal received by the sector antennas in a set, in other embodiments fewer frequency converters 305 are included. For example, in the three sector example above, only two frequency converters 305 may be included. The frequency converters 305 may convert two of the signals to different frequencies f1 and f2, while a third signal remains at frequency f0. The combiner 310 combines these signals, and because each of the signals are at different frequencies f0, f1, and f2, no conflict occurs even though one of the signals was not converted. Accordingly, in these embodiments, the base station 201 only includes as many frequency converters 305 as are needed for uplink signals to be combined at different frequencies. In less optimal embodiments, even fewer frequency converters 305 may be used, where some of the uplink signals are combined even though they are at the same frequency.

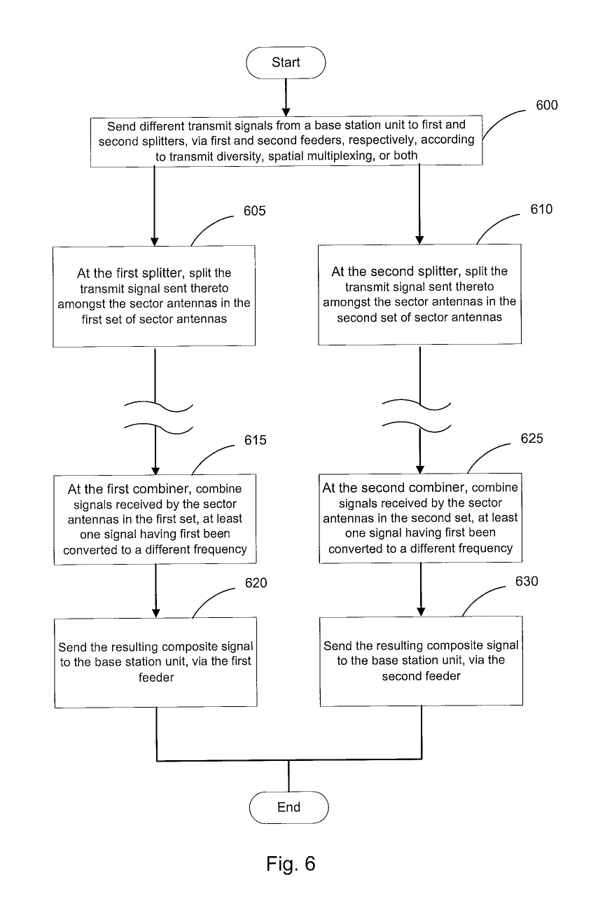

With the above modifications and variations in mind, those skilled in the art will appreciate that the base station 201 of the present invention generally performs the method illustrated in FIG. 6 for providing radio communication coverage for a geographic area 203. The method “starts” by sending different transmit signals from the base station unit 208 to first and second splitters 310A and 310B, via first and second feeders 212A and 212B, respectively, according to transmit diversity, spatial multiplexing, or both (Block 600). The method continues by, at the first splitter 310A, splitting the transmit signal sent thereto amongst the sector antennas 210 in the first set (Block 605), and, at the second splitter 310B, splitting the transmit signal sent thereto amongst the sector antennas 210 in the second set (Block 610).

The method also includes, not necessarily afterwards in time, at the first combiner 315A, combining signals received by the sector antennas 210 in the first set, with at least one of those signals having first been converted to a different frequency (Block 615). The first combiner 315A then sends the resulting composite signal to the base station unit 208 via the first feeder 212A (Block 620). The method further includes, at the second combiner 315B, combining signals received by the sector antennas 210 in the second set, with at least one of those signals having first been converted to a different frequency (Block 625). The second combiner 315B likewise sends the resulting composite signal to the base station unit 208 via the second feeder 212B (Block 630).

Those skilled in the art will appreciate that the various “circuits” described may refer to a combination of analog and digital circuits, including one or more processors configured with software and/or firmware (e.g., stored in memory) that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Those skilled in the art will also appreciate that the mobile terminals discussed herein may comprise a mobile telephone, a Portable Digital Assistant, a laptop computer, or the like. Moreover, those skilled in the art will appreciate that no particular communication interface standard is necessary for practicing the present invention. The mobile communication system discussed, therefore, may be based on any one of a number of standardized communication implementations, including GSM, CDMA (IS-95, IS-2000), TDMA (TIA/EIA-136), wide band CDMA (W-CDMA), GPRS, long term evolution (LTE), or other type of wireless communication system.

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A multi-sector omni-radio base station configured to provide radio communication coverage for a geographic area, the base station comprising:
a first set of sector antennas that provide coverage for different sectors of the geographic area;
a second set of sector antennas that provide coverage for some of those same sectors;
first and second splitters, each configured to split a signal sent thereto amongst the sector antennas in the first or second set, respectively;
a base station unit configured to send different transmit signals to the first and second splitters, via first and second feeders, respectively, according to transmit diversity, spatial multiplexing, or both;
first and second combiners, each configured to combine signals received by the sector antennas in the first or second set, respectively, at least one of those signals having first been converted to a frequency different from that at which it was received, and to send the resulting composite signal to the base station unit, via the first or second feeder, respectively.

2. The base station of claim 1, wherein the base station unit is configured to send different transmit signals to the first and second splitters according to transmit diversity, the different transmit signals representing the same data, but differing in one or more transmission parameters.

3. The base station of claim 1, wherein the base station unit is configured to send different transmit signals to the first and second splitters according to spatial multiplexing, the different transmit signals representing different data.

4. The base station of claim 1, wherein the base station unit includes first and second power amplifiers for amplifying the different transmit signals.

5. The base station of claim 1, further comprising one or more additional sets of sector antennas that provide coverage for some of the same sectors, one or more additional splitters, each configured to split a signal sent thereto amongst the sector antennas in a respective one of the one or more additional sets, and wherein the base station unit is configured to send different transmit signals to the first splitter, the second splitter, and the one or more additional splitters, via the first feeder, the second feeder, and one or more additional feeders, respectively, according to transmit diversity, spatial multiplexing, or both.

6. The base station of claim 5, wherein the base station unit includes a plurality of power amplifiers for amplifying the different transmit signals, and wherein the base station comprises as many splitters, and as many feeders, as there are of said power amplifiers.

7. The base station of claim 1, wherein the base station unit is configured to receive the resulting composite signals from the first and second combiners over the first and second feeders according to receive diversity, spatial multiplexing, or both.

8. The base station of claim 1, wherein the base station unit is configured to receive the resulting composite signals from the first and second combiners over the first and second feeders according to receive diversity, the resulting composite signals representing the same data, but differing in one or more transmission parameters.

9. The base station of claim 1, wherein the base station unit is configured to receive the resulting composite signals from the first and second combiners over the first and second feeders according to spatial multiplexing, the resulting composite signals representing different data.

10. The base station of claim 1, further comprising at least one frequency converter configured to convert a signal received by a sector antenna in the first set to a frequency different from that at which it was received and at least one other frequency converter configured to convert a signal received by a sector antenna in the second set to a frequency different from that at which it was received.

11. The base station of claim 1, further comprising at least one multi-signal frequency converter configured to convert multiple signals to multiple different frequencies, the multiple different frequencies being both different from one another and different from any frequency at which the multiple signals were received.

12. A method implemented by a multi-sector omni-radio base station for providing radio communication coverage for a geographic area, the method comprising:
sending different transmit signals from a base station unit to first and second splitters, via first and second feeders, respectively, according to transmit diversity, spatial multiplexing, or both;
at each of the first and second splitters, splitting the transmit signal sent thereto amongst the sector antennas in a first or a second set of sector antennas, respectively, the sector antennas in the first set providing coverage for different sectors of the geographic area and the sector antennas in the second set providing coverage for some of those same sectors;
at each of first and second combiners, combining signals received by the sector antennas in the first or second set, respectively, at least one of those signals having first been converted to a frequency different from that at which it was received, and sending the resulting composite signal to the base station unit, via the first or second feeder, respectively.

13. The method of claim 12, wherein sending different transmit signals from the base station unit comprises sending different transmit signals according to transmit diversity, the different transmit signals representing the same data, but differing in one or more transmission parameters.

14. The method of claim 12, wherein sending different transmit signals from the base station unit comprises sending different transmit signals according to spatial multiplexing, the different transmit signals representing different data.

15. The method of claim 12, further comprising amplifying the different transmit signals at first and second power amplifiers included in the base station unit.

16. The method of claim 12:
wherein sending different transmit signals from the base station unit comprises sending different transmit signals to the first splitter, the second splitter, and one or more additional splitters, via the first feeder, the second feeder, and one or more additional feeders, respectively, according to transmit diversity, spatial multiplexing, or both; and
wherein the method further comprises, at one or more additional splitters, splitting the transmit signal sent thereto amongst the sector antennas in one or more additional sets of sector antennas, respectively.

17. The method of claim 16, further comprising amplifying the different transmit signals at a plurality of power amplifiers included in the base station unit, and wherein the base station comprises as many splitters, and as many feeders, as there are of said power amplifiers.

18. The method of claim 12, further comprising receiving at the base station unit the resulting composite signals from the first and second combiners over the first and second feeders according to receive diversity, spatial multiplexing, or both.

19. The method of claim 12, further comprising receiving at the base station unit the resulting composite signals from the first and second combiners over the first and second feeders according to receive diversity, the resulting composite signals representing the same data, but differing in one or more transmission parameters.

20. The method of claim 12, further comprising receiving at the base station unit the resulting composite signals from the first and second combiners over the first and second feeders according to spatial multiplexing, the resulting composite signals representing different data.
